(19) United States
(12) Patent Application Publication
(10) Pub. No.: US 2008/0028115 A1
(43) Pub. Date: Jan. 31, 2008

(54) Computer system status monitoring circuit

(75) Inventors: Xiao-Zhu Chen, Shenzhen (CN); Ke Sun, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/636,276

(22) Filed: Dec. 8, 2006

(30) Foreign Application Priority Data
Jul. 28, 2006 (CN) 200610061867.3

(51) Int. Cl. G06F 13/00

(52) U.S. Cl. 710/110

(57) ABSTRACT

A computer system status monitoring circuit for monitoring status of a plurality of computer devices in a computer system is provided. The computer system status monitoring circuit includes an inter-integrated circuit (I2C) bus electrically connected to the computer devices for receiving and transmitting data of the computer devices corresponding to the status of the computer devices, an I2C bus controller connected to the I2C bus for selecting one of the computer devices as a master and controlling the I2C bus to receive the data of the master computer device, and a display device connected to the I2C bus for displaying the data of the master computer device.

### BACKGROUND

1. Field of the Invention

The present invention relates to computer system status monitoring circuits, and particularly relates to a computer system status monitoring circuit based on an inter-integrated circuit (I2C) bus.

2. General Background

The I2C bus is a two-wire serial bus used extensively in a variety of microcontroller-based professional, consumer, and telecommunications applications as a control, diagnostic, and power management bus.

The I2C bus comprises two wires called SCL and SDA. The SCL is a clock line used to synchronize all data transfers over the I2C bus. The SDA is a data line. The devices on the I2C bus are either masters or slaves. The master is always the device that drives the SCL clock line. The slaves are the devices that respond to the master. A slave cannot initiate a transfer over the I2C bus; only a master can do that. There can be, and usually are, multiple slaves on the I2C bus, however there is normally only one master. Both master and slave can transfer data over the I2C bus, but the master always controls the transfer.

Nowadays, the I2C bus is usually used to acquire data from a computer system such as operating temperature, rotation speed of a fan mounted in the computer system, and available memory space and so on. However, the data acquired by the I2C bus can only be accessed by calling the basic input output system (BIOS), even worse, it is difficult to search and find out the needed data in the BIOS.

What is needed is a computer system status monitoring circuit which can easily monitor and display the status of a computer system.

### SUMMARY

An exemplary computer system status monitoring circuit for monitoring status of a plurality of computer devices in a computer system is provided. The computer system status monitoring circuit includes an inter-integrated circuit (I2C) bus electrically connected to the computer devices for receiving and transmitting data of the computer devices corresponding to the status of the computer devices, an I2C bus controller connected to the I2C bus for selecting one of the computer devices as a master and controlling the I2C bus to receive the data of the master computer device, and a display device connected to the I2C bus for displaying the data of the master computer device.

Other advantages and novel features will become more apparent from the following detailed description when taken in conjunction with the accompanying drawing, in which:

### BRIEF DESCRIPTION OF THE DRAWINGS

FIG. 1 is a block diagram of a computer system status monitoring circuit in accordance with a preferred embodiment of the present invention, the computer system status monitoring circuit has a display device; and

FIG. 2 is a circuit diagram of the display device of FIG. 1.

### DETAILED DESCRIPTION OF THE EMBODIMENT

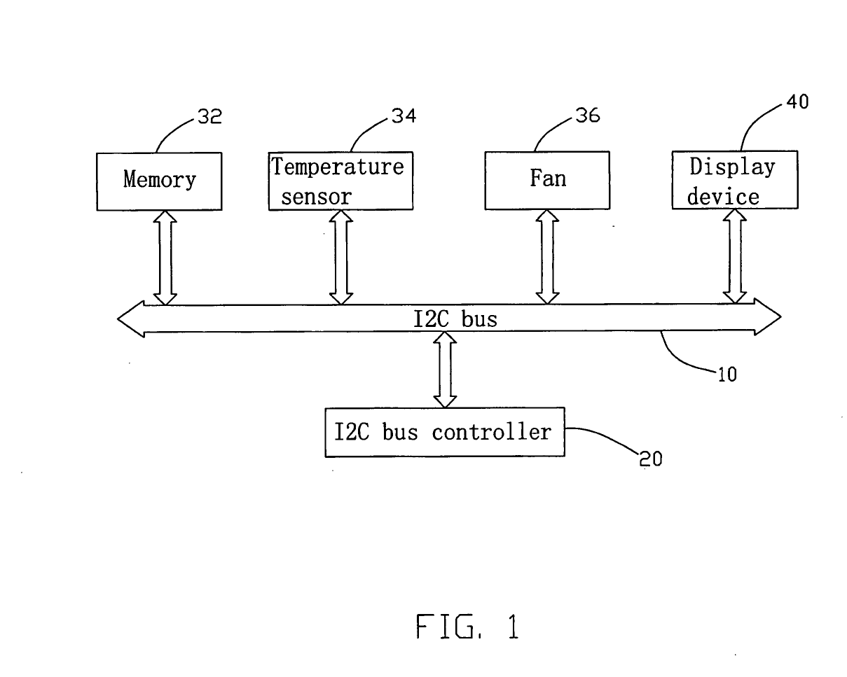

Referring to FIG. 1, a computer system status monitoring circuit in accordance with a preferred embodiment of the present invention is shown. The computer system status monitoring circuit includes an I2C bus 10, an I2C bus controller 20, a plurality of computer devices (this embodiment uses a memory 32, a temperature sensor 34, and a fan 36 as an example) in the computer system, and a display device 40.

The I2C bus controller 20, the computer devices, and the display device 40 are connected to the I2C bus 10. The I2C bus 10 includes a data line SDA, and a clock line SCL used to synchronize all the computer devices over the I2C bus 10.

The I2C bus controller 20 controls the master of the I2C bus 10, which means that the I2C bus controller 20 determines which of the computer devices masters the I2C bus 10, then the computer device mastering the I2C bus 10 can transfer data over the I2C bus 10. In this embodiment, the temperature sensor 34 is used as an example to explain how the computer devices work with the I2C bus controller 20, the display device 40, and the I2C bus 10. When the temperature sensor 34 becomes the master of the I2C bus 10, the display device 40 is a slave. The temperature sensor 34 senses a temperature of the computer system, and transfers a value of the sensed temperature to the display device 40 for display.

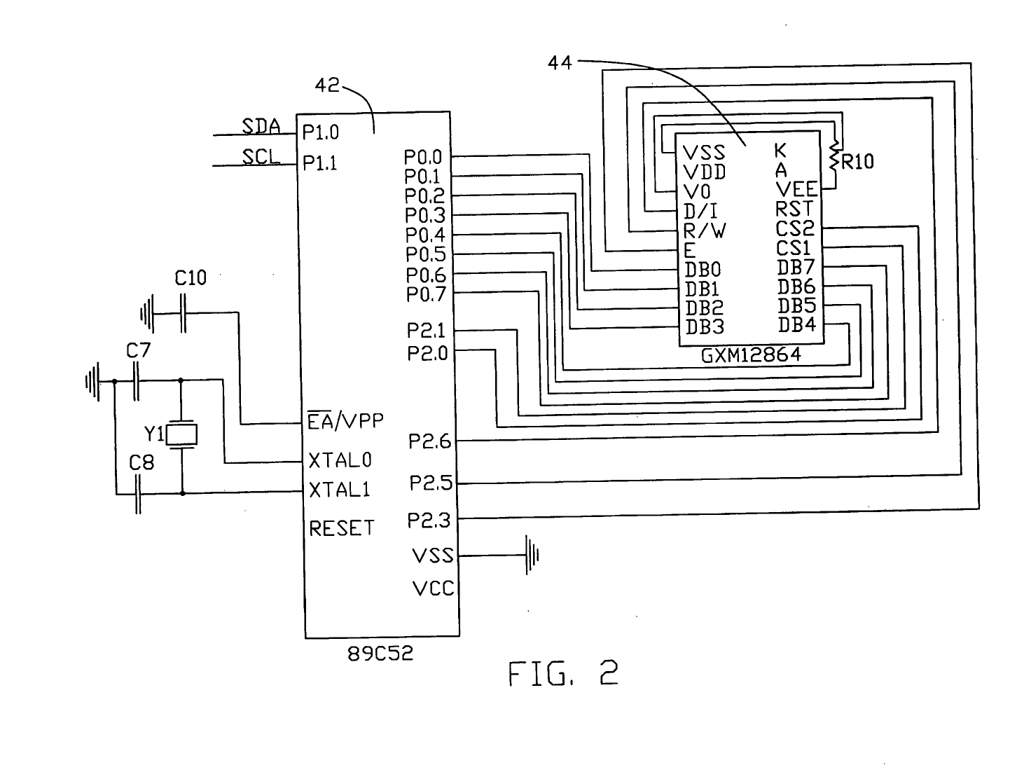

Referring also to FIG. 2, the display device 40 includes a chip 42, and a display module 44. In this embodiment, the chip 42 is a microprocessor 89C52, which is made by American ATMEI Company. The chip 42 is a 40-pin Dual in-line chip. The chip 42 includes P0.0-0.7 pins, a P1.0 pin, a P1.1 pin, a P2.0 pin, a P2.1 pin, a P2.3 pin, a P2.5 pin, a P2.6 pin, a VCC pin, a VSS pin, an E̅A̅/VPP pin, an XTAL0 pin, an XTAL1 pin, and a RESET pin. In the chip 42, the P0.0-0.7 pins are used as data output ports, the VCC pin is connected to an external power source, the VSS pin is grounded to power ground, and the P1.0 pin and the P1.1 pin are used as I2C bus analog ports, the SDA line of the I2C bus 10 is connected to the P1.0 pin, and the SCL line of the I2C bus 10 is connected to the P1.1 pin. The E̅A̅/VPP pin is an external access enable port, when the E̅A̅/VPP pin receives a low level signal, the chip 42 can be accessed and is programmable. The XTAL0 pin and the XTAL1 pin are connected to a clocking circuit consisting of a crystal oscillator Y1, and two capacitors C7 and C8. The clocking circuit is used for providing working clock signals according to need. The RESET pin is a reset port.

The display module 44 is a GXM12864 dot pattern liquid-crystal display (LCD) which is made by the Nanjing Guoxian Electronics Corporation of China. The display module 44 includes DB0-DB7 pins, a VDD pin, a K pin, an A pin, a VEE pin, a VSS pin, a V0 pin, a CS1 pin, a CS2 pin, a D/I pin, an R/W pin, an E pin, and an RST pin. The DB0-DB7 pins are connected to the P0.0-0.7 pins of the chip 42 respectively. The VDD pin is used for connecting to an external power source. The K pin and the A pin are connected to a back light power source, and the VEE pin is connected to a liquid crystal drive power source. The VEE pin is also connected to the VSS pin of the display module 44 via a rheostat R10. The V0 pin is connected to an adjusting bar of the rheostat RIO for adjusting a contrast of the display module 44. The CS1 pin and the CS2 pin are chip selection ports connected to the P2.1 pin and the P2.0 pin of the chip 42 respectively. The D/I pin and the R/W pin are connected to the P2.6 pin and the P2.5 pin of the chip 42 respectively. The E pin is a signal-enable port, which is connected to the P2.3 pin of the chip 42. The RST pin is a reset port.

A clock signal produced by the temperature sensor 34 is transmitted to the P1.1 pin of the chip 42 via the SCL line of the I2C bus 10. The temperature sensor 34 senses a temperature of the computer system, and converts an analog signal of the sensed temperature into a digital signal. The temperature sensor 34 transmits the digital signal serially to the P1.0 pin of the chip 42 via the SDA line of the I2C bus 10. The chip 42 transforms the digital signal into a display signal and transmits the display signal to the DB0-DB7 pins of the display module 44 via the P0.0-0.7 pins of the chip 42. Then the display module 44 displays the temperature sensed by the temperature sensor 34.

When the memory 32 or the fan 36 becomes the master of the I2C bus 10, the available space of the memory 32 or the rotation speed of the fan 36 and so on is conveniently displayed on the display module 44 for a user.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment.

What is claimed is:

1. A computer system status monitoring circuit for monitoring status of a plurality of computer devices in a computer system, the computer system status monitoring circuit comprising:
an inter-integrated circuit (I2C) bus electrically connected to the computer devices for receiving and transmitting data of the computer devices corresponding to the status of the computer devices;
an I2C bus controller connected to the I2C bus for selecting one of the computer devices as a master and controlling the I2C bus to receive the data of the master computer device; and
a display device connected to the I2C bus for displaying the data of the master computer device.

2. The computer system status monitoring circuit as claimed in claim 1, wherein when one of the computer devices is a master, the display device is a slave.

3. The computer system status monitoring circuit as claimed in claim 1, wherein the display device comprises a chip, and a display module, the chip receives the data of the computer devices and converts the data into a display signal, and the display module receives the display signal for displaying the data of the computer devices.

4. The computer system status monitoring circuit as claimed in claim 3, wherein the display module is a dot pattern liquid-crystal display having a back light power source.

5. A computer system status monitoring circuit, comprising:
an inter-integrated circuit (I2C) bus;
a plurality of computer devices electrically connected to the I2C bus;
an I2C bus controller connected to the I2C bus for controlling one of the computer devices as a master and controlling the I2C bus to receive data of the master computer device;
a chip connected to the I2C bus for receiving the data from the I2C bus and converting the data into a display signal; and
a display module connected to the chip for receiving the display signal and displaying the data of the computer devices.

6. The computer system status monitoring circuit as claimed in claim 5, wherein when one of the computer devices is a master, the display device is a slave.

7. The computer system status monitoring circuit as claimed in claim 5, wherein the display module is a dot pattern liquid-crystal display having a back light power source.
